(19) United States
(12) Patent Application Publication
(10) Pub. No.: US 2010/0005117 A1
(43) Pub. Date: Jan. 7, 2010

(54) DISTRIBUTED SHARED DATA SPACE FOR PERSONAL HEALTH SYSTEMS

(75) Inventors: Wim J. J. Stut, Eindhoven (NL); Frank Wartena, Den Bosch (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/375,414

(22) PCT Filed: Jul. 18, 2007
(86) PCT No.: PCT/US2007/073735

§ 371 Date: Jan. 28, 2009

Related U.S. Application Data
(60) Provisional application No. 60/820,614, filed on Jul. 28, 2006.

(51) Int. Cl. G06F 17/30

(52) U.S. Cl. 707/104.1; 707/E17.044

(57) ABSTRACT

A system for data acquisition, storage, and access includes a plurality of electronic devices (10, 12, 14, 150, 154) having storage. Interfacing software defines setup instructions (70) for establishing on each electronic device a shared data space (30, 130) configured to store one or more data streams (32, 34, 132, 134) of temporally ordered time stamped values, acquisition instructions (76) executable by at least one device (10, 12, 150) of the one or more electronic devices to acquire and store in a first data stream (32, 132) of the shared data space time stamped samples acquired from a first data source (16, 116) at a first temporal acquisition frequency, output instructions (78) executable by at least one device (12, 14, 150, 154) of the one or more electronic devices to output to a first application (50, 160, 162, 164) selected values from the first data stream at a first application first data stream access frequency, and acquisition control instructions (80) executable by at least one device (12, 14, 150, 154) of the one or more electronic devices to instruct the system to start the continuous acquisition of data samples at a specified frequency and moment.

The following relates to the data acquisition, storage, and access arts. It is described with example application to acquisition and storage of medical data and access to such acquired and stored data. However, the following will find application in acquisition, storage, and access of other types of data.

Medical data acquisition, storage, and access is an enabling technology for a wide range of medical and personal health techniques. For example, development and maintenance of an exercise program is facilitated by feedback provided by medical data acquisition, storage, and access. In an exercise program, it is useful to analyze diagnostic physiological information such as heart rate, blood pressure, or so forth measured before, during, and/or after exercising. As another application, a doctor may want to monitor heart rate, blood pressure, SpO₂ level, or so forth periodically (e.g., once per hour) for use in diagnosing a chronic medical problem such as occasional chest pain or breathing difficulty. The exercise monitoring and diagnostic monitoring may be performed concurrently, but with very different temporal parameters. For example, both exercise monitoring and medical diagnostic monitoring may utilize samples of the heart rate. However, the exercise monitoring will likely employ a relatively fast sampling rate (e.g., ten samples per minute) over a relatively short period of time (e.g., a 30-minute run). In contrast, the diagnostic monitoring of a chronic problem may employ less frequent sampling (e.g., one heart rate sample per hour) but acquired over a more extended period of time (e.g., days, weeks, or months).

In some applications, it is desirable to separate the acquisition and storage of medical data from its subsequent access. For example, monitoring data for diagnosing a chronic problem may be useful only in the aggregate, for example by looking for trends in the data over days, weeks, or months. On the other hand, during exercise the data may be preferably accessed almost simultaneously with its acquisition and storage, so that the person engaged in the exercise can receive immediate feedback.

A system for acquiring, storing, and accessing medical data should be flexible and robust. It should be able to support different sensors, different data storage devices, different sampling rates, different delays between storage and access, and so forth. Addition of a new sensor or storage device should be convenient. Activation of a new application that accesses the acquired and stored data should also be convenient. The system should also be robust against failure of one or a few devices. For example, failure of one sensor or storage device should not shut down the overall system. Moreover, since the person being monitored is typically moving about, various operative connections (e.g., wireless communication connections) may be initiated or broken in a substantially random manner. The overall system should be robust against such intermittencies in communication between devices.

Existing systems and methods for acquiring, storing, and accessing medical data have certain disadvantages. In some systems, the data acquisition, storage, and access is closely integrated with the end-application. For example, in a common arrangement the heart rate sensor of an exercise monitor is integrated with its storage and readout device, while the doctor's heart rate sensor is integrated with its own separate storage unit. The person must wear both heart rate monitoring devices during exercise to support both applications simultaneously. Additionally, failure of either heart rate sensor effectively shuts down the corresponding application. More generally, existing systems do not provide convenient techniques for allowing data from a sensor to be used in different ways by two or more different applications. Existing systems also do not provide convenient techniques for sharing data from one sensor amongst a plurality of electronic devices that may store and provide access to the data.

Example system, method, and storage medium or media embodiments are disclosed.

In an example embodiment system for data acquisition, storage, and access, an electronic device has storage. At least a portion of the storage of the electronic device contains a shared data space configured to store one or more data streams of temporally ordered time-stamped values. One or more data sources are provided. Interfacing software defines: (i) acquisition instructions executable by the electronic device to acquire and store in a first data stream of the shared data space time-stamped samples acquired from a first data source of the one or more data sources at a first temporal acquisition frequency; (ii) output instructions executable by the electronic device to output to a first application selected values from the first data stream at a first application first data stream access frequency; and (iii) acquisition control instructions executable by the electronic device to request the continuous acquisition of data samples at a specified frequency.

In an example embodiment method for data acquisition, storage, and access, a shared data space is defined. The shared data space is configured to store one or more data streams of temporally ordered time-stamped values. Time-stamped samples acquired from a first data source at a first temporal acquisition frequency are acquired and stored in a first data stream of the shared data space. Selected values from the first data stream are output to a first application at a first application first data stream access frequency.

In an example storage medium or media embodiment, a storage medium or media stores interfacing software for use in conjunction with data acquisition, storage, and access. The interfacing software defines: (i) setup instructions for establishing on each of one or more electronic devices having storage an instance of a shared data space configured to store one or more data streams of temporally ordered time stamped values; (ii) acquisition instructions executable by at least one device of the one or more electronic devices to acquire and store in a first data stream of the shared data space time stamped samples acquired from a first data source at a first temporal acquisition frequency; (iii) output instructions executable by at least one device of the one or more electronic devices to output to a first application selected values from the first data stream at a first application first data stream access frequency; and (iv) acquisition control instructions executable by at least one device of the one or more electronic devices to instruct the system to start the continuous acquisition of data samples at a specified frequency and moment.

In an example electronic device embodiment, an electronic device includes storage which contains a shared data space configured to store one or more data streams of temporally ordered time stamped values, and a processor which executes instructions to acquire and store in a first data stream of the shared data space time-stamped samples acquired from a first data source of the one or more data sources at a first temporal acquisition frequency and to output to a first application selected values from the first data stream at a first application first data stream access frequency.

One advantage resides in improved flexibility in acquiring, storing, and accessing data.

Another advantage resides in improved robustness in systems for acquiring, storing, and accessing data.

Another advantage resides in facilitating use of data from a sensor in different ways by two or more different applications.

Another advantage resides in enhanced ability to share data from a sensor amongst a plurality of electronic devices that may store and provide access to the data.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

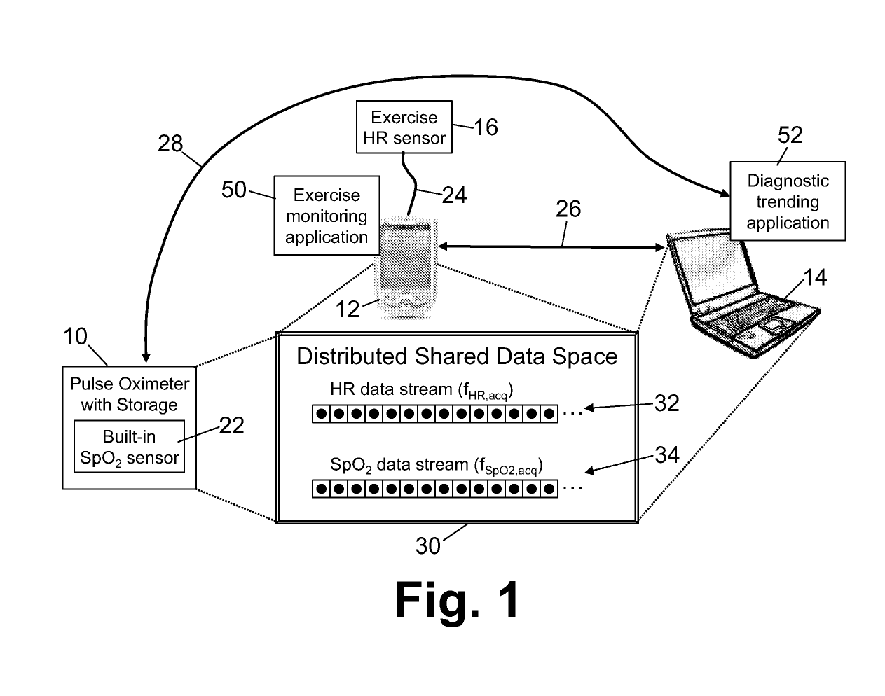

FIG. 1 diagrammatically shows a personal health system.

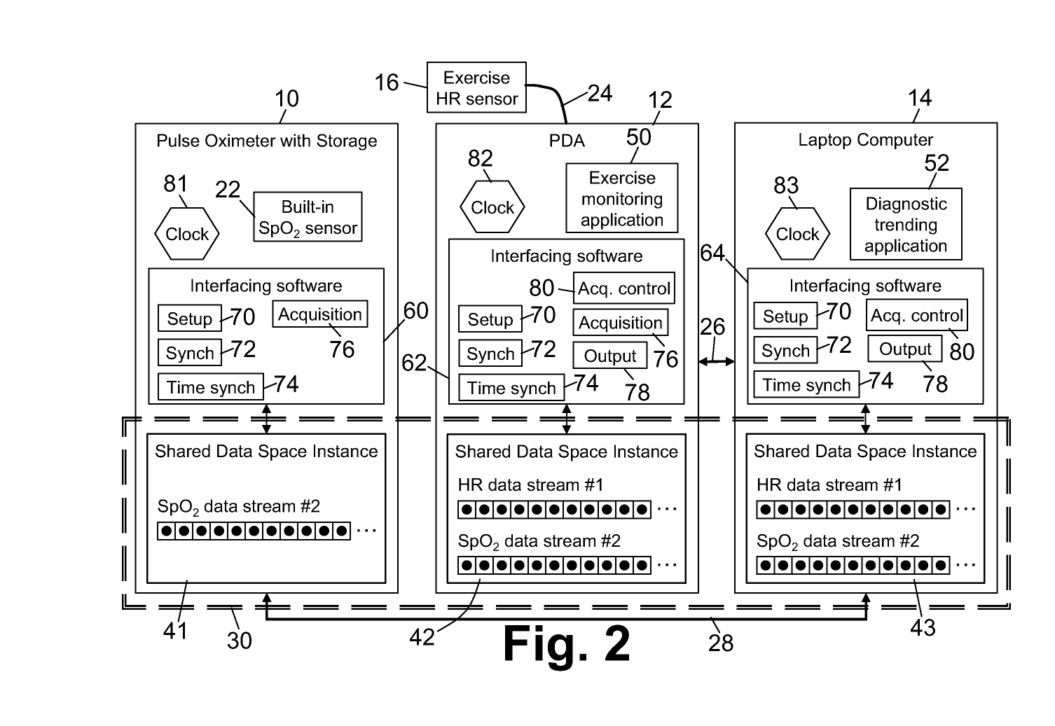

FIG. 2 diagrammatically shows the personal health system of FIG. 1, including additional detail regarding software and data flow.

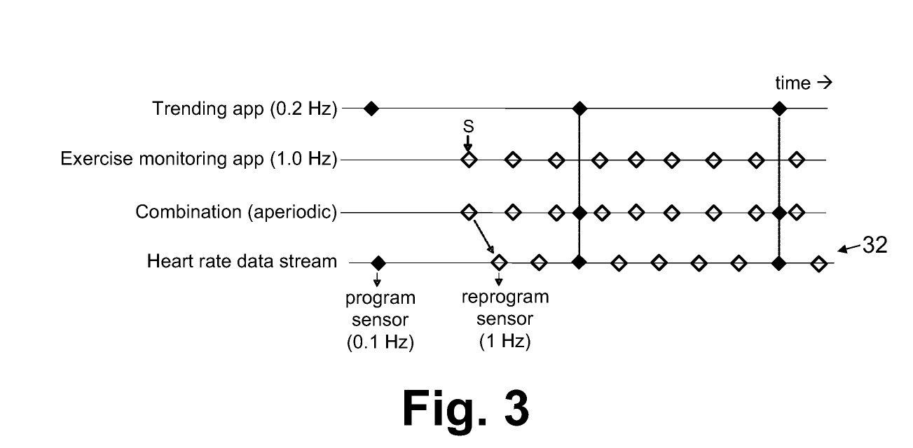

FIG. 3 diagrammatically shows adjustment of sampling rate to efficiently accommodate initiation of a second application.

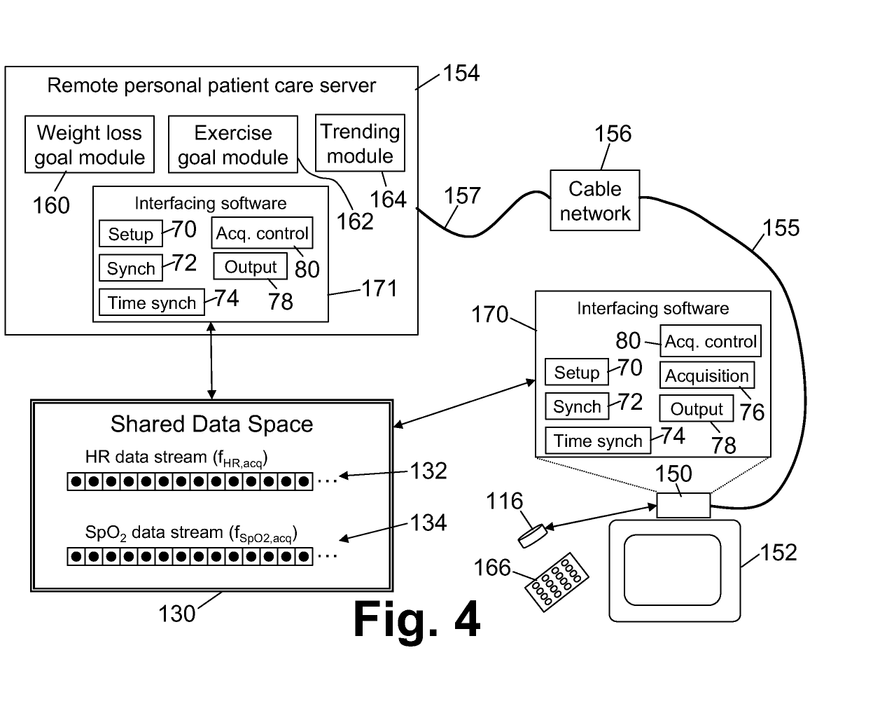

FIG. 4 diagrammatically shows a personal health system that incorporates a patient's television or entertainment system and a remote personal patient care server.

With reference to FIGS. 1 and 2, an illustrated example personal health system includes a plurality of devices, namely a pulse oximeter 10, personal data assistant (PDA) 12, a laptop computer 14, and an exercise heart rate sensor 16. The pulse oximeter 10 employs an optically based sensor that effectively provides a built-in blood oxygenation (SpO₂) sensor 22. The devices 10, 12, 14, 16 are typically mobile devices, but may also be stationary devices. For example, the pulse oximeter 10 is in some embodiments a wearable monitor that is continuously worn by a patient during an extended monitoring period of several days to several weeks. The PDA 12 is carried by the patient at least some of the time, but may also be left at home, in the office, or elsewhere. The laptop computer 14 may for example be under the control of the patient's physician, and may stay at the physician's office or may be carried with the physician. The exercise heart rate sensor 16 is typically worn by the patient when the patient is engaged in an exercise session, such as a running session. In the illustrated example embodiment, the pulse oximeter 10, PDA 12, and laptop computer 14 each contain internal storage for storing a substantial amount of digital data, while the exercise heart rate sensor 16 does not include a substantial amount of internal storage and is able to store the current heart rate reading or other similarly limited amount of data.

The various devices 10, 12, 14, 16 have various example connectivity capabilities. The example heart rate monitor 16 can connect with the PDA 12 via a wired connector 24 such as a USB connector, FireWire connector, or so forth. The PDA 12 and the physician's laptop computer 14 can connect wirelessly via suitable wireless connectivity 26 such as Bluetooth, ZigBee, WLAN, or so forth, or via a suitable wired PDA docking port, or so forth. The pulse oximeter 10 in some embodiments connects with the physician's laptop computer 14 via a telephonic modem connection 28, which the patient initiates by dialing a pre-selected telephone number and connecting or placing the pulse oximeter 10 close to the telephone or telephone handset. In some such embodiments, the pulse oximeter communicates via the telephonic modem connection 28 with a computer network (not shown) that in turn communicates with the laptop computer 14. Alternatively, a wireless or wired connection can be used to connect the pulse oximeter 10 with the physician's laptop computer 14.

Although various of the devices 10, 12, 14, 16 have various connectivity capabilities, it will be appreciated that operative connections between the devices may be initiated or broken in a substantially random manner. For example, operative connection between the exercise heart rate sensor 16 and the PDA 12 may be initiated when the person manually connects the connector 24 to both devices 12, 16 with both devices turned on or activated. This operative connection is broken when the connector 24 is detached from either device 12, 16, or when either device 12, 16 is turned off or deactivated. Similarly, wireless connections of limited range (such as Bluetooth or ZigBee) are typically initiated when two compatible operating devices come within sufficiently close proximity to each other, and are broken when one device is moved out of range of the other device. Hence, an operative Bluetooth connection between the PDA 12 and the physician's laptop computer 14 is unlikely to be present except when the patient visits the physician's office (so that the PDA 12 is physically close to the laptop computer 14). Similarly, the telephonic modem connection 28 exists only briefly when the patient establishes the telephone connection.

To facilitate robust and flexible data acquisition, storage, and access in the face of such intermittencies in communication between the devices 10, 12, 14, 16 of the system, a distributed shared data space 30 is used. The distributed shared data space 30 is configured to store one or more data streams, such as an illustrated heart rate data stream 32 and an illustrated SpO2 data stream 34. Each data stream 32, 34 is a stream of temporally ordered time-stamped values that are acquired at a selected acquisition frequency, e.g. acquisition frequency f_{HR,acq} for the heart rate data stream 32 and acquisition frequency f_{SpO2,acq} for the SpO₂ data stream 34. The distributed shared data space 30 is shared in that the several data streams 32, 34 share or are stored in a common shared data space. The illustrated distributed shared data space 30 is distributed in that the system includes several devices 10, 12, 14 that have storage and the distributed shared data space 30 is stored or distributed over these several devices 10, 12, 14 by having an instance of the data space 30 stored on each device 10, 12, 14. Thus, in the illustrated embodiment with three devices 10, 12, 14 having storage, an instance 41 of the distributed shared data space 30 is stored on the pulse oximeter 10, an instance 42 of the distributed shared data space 30 is stored on the PDA 12, and an instance 43 of the distributed shared data space 30 is stored on the laptop computer 14.

The fact that the data space is distributed over several devices does not necessarily imply that each device has a copy of each data stream. In the illustrated embodiment each device 10, 12, 14 has a copy of the SpO₂ data stream; however, only the device 12, 14 have a copy of the heart rate data stream. The reason for the device 10 not having a copy of the heart rate data stream is that this device does not produce heart rate samples, and has no application that needs heart rate samples as input. If a device is not connected to any other device that takes part in the data space, the applications on this device only have access to the data that is stored locally; otherwise the applications can have access to the data stored at the other connected devices in a fully transparent manner.

Two example applications 50, 52 that use heart rate data are illustrated. The first application 50 is an exercise monitoring application running on the PDA 12. The exercise monitoring application 50 displays the heart rate output from the heart rate data stream 32 substantially in real time on the PDA display, for example by updating the heart rate display once every second. The exercise monitoring application 50 is typically loaded before beginning an exercise session, and is typically terminated shortly after the exercise session is complete. It requires a relatively high sampling rate for the heart rate data stream 32 (e.g., f_{HR,acq}=1 Hz) to enable substantially real time heart rate display, but is operative only during the exercise session.

The second application 52 is a diagnostic trending application running on the laptop computer 14. The diagnostic trending application 52 displays graphs of heart rate and SpO₂ level output from the heart rate data stream 32 and the SpO₂ data stream 34, respectively, each plotted as a function of time. Such a graph or graphs can be used by the physician to locate trends in the heart rate or SpO₂ level over a period of days or weeks that may indicate improvement or worsening of a chronic condition affecting the heart or blood oxygenation. The diagnostic trending application 52 typically employs a low sampling rate compared with the exercise-related application 50; for example, a rate of one heart rate and SpO₂ sample per hour may be sufficient. However, the heart rate sampling for the diagnostic heart rate monitoring application 52 executes continuously over an extended period of days or weeks, so as to provide sufficient information for long-term trending.

Interfacing software is provided to interface between the applications 50, 52 and the data streams 32, 34 of the distributed shared data space 30. Typically, the interfacing software is supplied on one or more magnetic diskettes, one or more optical disks, on a storage medium or media accessible via an Internet server, on a wirelessly accessible storage medium or media of a server of a wireless (cellular) telephone network, or so forth. It is also contemplated to have the interfacing software supplied as firmware of one or more of the devices with storage (the term “software” is to be broadly construed herein as encompassing so-called “firmware” in which the software is stored in a non-volatile memory such as a read-only memory (ROM)), or on another storage medium or media. Instances of the interfacing software (or portions thereof) are installed on each device 10, 12, 14 having memory of the system. In the illustrated embodiment, the pulse oximeter 10 has an installed instance 60 of the interfacing software, the PDA 12 has an installed instance 62 of the interfacing software, and the physician's laptop computer 14 has an installed instance 64 of the interfacing software.

The interfacing software defines setup instructions 70 executable by one or more of the devices 10, 12, 14 to generate the instances 41, 42, 43 of the distributed shared data space, synchronization instructions 72 executable by one or more of the devices 10, 12, 14 to synchronize the instances 41, 42, 43 of the distributed shared data space, time synchronization instructions 74 executable by one or more of the devices 10, 12, 14 to temporally synchronize the devices 10, 12, 14, acquisition instructions 76 executable by one or more of the devices 10, 12, 14 to acquire and store in a selected data stream of the shared data space 30 time-stamped samples acquired from a data source at a selected temporal acquisition frequency, output instructions 78 executable by one or more of the devices 10, 12, 14 to output to an application selected values from a selected data stream at a selected application data stream access frequency, acquisition control instructions 80 executable by one or more of the devices 10, 12, 14 to instruct the system to start the continuous acquisition of data samples at a specified frequency and moment, or so forth. As illustrated in FIG. 2, the different instances 60, 62, 64 of the interfacing software may include a sub-set of these instructions. In example FIG. 2, all three devices 10, 12, 14 include the setup, synchronization, and time synchronization instructions 70, 72, 74. However, the pulse oximeter 10 includes the acquisition instructions 76 but not the output instructions 78 and not the acquisition control instructions 80, since the pulse oximeter is not designed to execute any application programs. Conversely, the physician's laptop computer 14 includes the output instructions 78 but omits the acquisition instructions 76, since the laptop computer is not designed to acquire data for any of the data streams 32, 34. The PDA 12 includes both the acquisition instructions 76 and the output instructions 78, since it performs both acquisition and output tasks. Both the PDA 12 and the laptop computer 14 include the acquisition control instructions 80, since they both have an application that instructs the system to start the continuous acquisition of data samples.

The use of the interfacing software effectively hides the sensors 16, 22 from the applications 50, 52: each application 50, 52 specifies what kind of data it needs (e.g., heart rate, SpO₂) and an access frequency for each kind of data (that is, for each data stream). The interfacing software identifies a data stream for the appropriate sensor (or a suitable new data stream is set up using the setup instructions 70). If no suitable data stream exists and one cannot be set up (typically because there is no available sensor for measuring the kind of data requested) then the interfacing software warns the application that the requested kind of data cannot be accessed. The data of each kind (e.g., heart rate, SpO₂) is collected and stored in the distributed shared data space 30, and can serve as basis for multiple applications. For example, the same heart rate data stream 32 can supply data to both the exercise monitoring application 50 and the diagnostic trending application 52. Advantageously, acquisition and storage, on the one hand, and access on the other hand, are independent and asynchronous operations. For example, the exercise monitoring application 50 can access the heart rate time-stamped samples almost as quickly as they are added to the heart rate data stream 32 by the acquisition instructions 76; whereas, the diagnostic trending application 52 can access the heart rate time-stamped samples days or weeks later, when the patient visits the physician's office.

The shared data space 30 operates on data streams 32, 34 rather than on single data items. The devices 10, 12, 14, 16 in the personal health system communicate via the distributed shared data space 30. The devices 10, 12, 14, 16 generally do not have detailed information about one another, beyond the information involved in establishing the communication links 24, 26, 28, and those connections can be initiated and broken randomly without unduly disrupting the overall system. The devices 10, 12, 14, 16 write and read samples to and from the shared data space 30 via generic acquisition and output instructions 76, 78 defined by the interfacing software.

In the illustrated example a personal health system embodiment, the data space 30 contains data (e.g., heart rate and SpO₂ data samples) for a single person, and is distributed as instances 41, 42, 43 over several nodes (namely the devices 10, 12, 14 having storage). These nodes with storage communicate with each other intermittently via wired or wireless connections 26, 28, with individual connections being occasionally initiated and later broken. Moreover, some devices may communicate indirectly with each other - for example, the pulse oximeter 10 does not directly communicate with the PDA 12. Rather, the shared data space instances 41, 42 on the pulse oximeter 10 and PDA 12, respectively, are synchronized indirectly via the intermediary of the laptop computer 14. The synchronizing instructions 72 defined by the interfacing software are responsible for moving or replicating data elements between the nodes 10, 12, 14 of the distributed shared data space 30. This synchronization is hidden for the application programs 50, 52 which operate at application-level functionality. Data from each sensor 16, 22 are typically acquired and stored in the appropriate data stream 32, 34 in the same order as produced by the sensors. The processing may take place substantially immediately (as in the case of the exercise monitoring application 50), or may take place later (as in the case of the trending application 52). The data streams 32, 34 of the shared data space 30 explicitly embody the data streaming concept, in which each data stream 32, 34 includes a time-ordered collection of time-stamped samples. It is to be appreciated that the acquisition frequency can be substantially any value, for example 100 Hz, 1 Hz, one sample per day, one sample per week, or so forth.

Each device 10, 12, 14 having storage can create a data stream using the setup instructions 70. When a new data stream is created, the type of the data elements or samples in the new data stream are specified. For example, the heart rate data stream 32 may have data type “HeartRate”, while the SpO₂ data stream 34 may have data type “Oxygenation”. Each data stream can be identified by a unique name. Once created, a data stream can be opened either for reading samples (using the output instructions 78) or for writing samples (using the acquisition instructions 76). In some embodiments, different readers may simultaneously access a stream at different positions and in different manners (such as at different access frequencies). Accordingly, opening a data stream returns an application-specific descriptor or handle that is subsequently used for all data stream accesses by that application.

During acquisition and storage, samples or elements can only be appended to a data stream. Each appended sample or element is assigned a time-stamp based on an internal clock of the device. For example, a sample acquired by the pulse oximeter 10 is assigned a time-stamp based on a clock 81 of the pulse oximeter 10, while a sample acquired by the PDA 12 is assigned a time-stamp based on a clock 82 of the PDA 12. Devices which do not acquire samples, such as the laptop computer 14, optionally may not include a clock. However, a clock 83 is optionally included on the laptop computer 14, for example to provide a “present time” temporal reference value for use by the trending application program 52.

To access or read data from a data stream, the application must first position itself in the data stream via a seek operation performed by the output instructions 78. Data elements are then read by the application. From the perspective of the data space 30, such reading is an output operation implemented by the output instructions 78. The effect of the read (or output) operation is that the application gets a copy of a data element. The application receives the samples in the same order as they have been added to the stream.

However, the application does not necessarily read every sample in the data stream. For example, an application may want to read a data stream at an access frequency that is different from the acquisition frequency. For example, the trending application 52 may want to read samples at a frequency of one heart rate sample per hour, but the data stream may have acquired samples at 1 Hz (so as to support the exercise monitoring program 50, for example). The application sets the access frequency as part of the application-specific descriptor or handle used by the application in reading the data stream. To accommodate this selectable access frequency, the output instructions 78 adapt the application readout position in the stream according to its access frequency.

The output instructions 78 optionally also include a delay option (preferably with a timeout feature) that blocks the caller if the end of the data stream is reached to wait for a next sample to be appended to the data stream. In some embodiments, the output instructions 78 may trigger additional acquisition of a sample (by communication with the acquisition instructions 76) when the end of a data stream is reached.

By means of the acquisition control instructions 80 applications can instruct the system to start the continuous acquisition of data samples at a specified frequency and moment. For example, the diagnostic trending application 52, uses these instructions to instruct the system to collect one heart rate and SpO₂ sample per hour, starting 3 hours from now. Callbacks can be deployed to handle exceptions, such as when there is no data available and the delay option times out without receiving an appended sample. The shared data space 30 hides how it actually collects data, and from which sensors. This enables decoupling of applications from specific hardware.

With reference to FIG. 3, to prevent duplicate measurements of samples of the same type, and to save energy in the sensor, it is advantageous to combine sampling requests for the same type of data by different applications. For example, the same heart rate data stream 32 is advantageously accessed by both the exercise monitoring application 50 and the trending application 52 to read heart rate samples. To implement such combined sampling, differences in acquisition rate should be accommodated. For example, the exercise monitoring application 50 may sample heart rate at 1.0 Hz, while the trending application 52 may sample heart rate at a slower rate, such as 0.2 Hz in the example of FIG. 3. It is advantageous to sample at the highest sampling rate requested by any application. In the example of FIG. 3, this fastest rate is f_{HR,acq}=1.0 Hz requested by the exercise monitoring application 50; however, this fastest rate is only needed during an exercise session. Before and after the exercise session, only the trending application 52 needs heart rate data, and so before and after the exercise session the fastest rate is f_{HR,acq}=0.2 Hz requested by the trending application 52.

To enable the same data stream to be used for multiple applications, in some embodiments the acquisition frequency is an integer multiple of each access frequency of the several applications, and is equal to the highest access frequency of any of the applications. When two applications read from the same data stream, this condition is met if the acquisition frequency is set to the highest access frequency and (i) the first application access frequency and the second application access frequency are equal, or (ii) the first application access frequency is an integer multiple of the second application access frequency, or (iii) the second application access frequency is an integer multiple of the first application access frequency. Since all frequencies are multiples of each other, sampling at the highest requested frequency will always satisfy all other requests if the sampling moments are properly aligned, for example by aligning sampling for a new access handle with the existing requests.

For example, the first line in example FIG. 3 shows the sampling times of the access handle for the trending application 52. Initially, only the trending application 52 has an open handle accessing the heart rate data stream 32, and so f_{HR,acq}=0.2 Hz which is sufficient to satisfy the requirements of the trending application 52. The second line of FIG. 3 shows that at a time S, the exercise monitoring application 50 opens a handle to the heart rate data stream 32 with a requested sampling rate of 1 Hz. The 1 Hz rate is acceptable since it is an integer multiple of (5×) the 0.2 Hz sampling rate of the trending application 52, and so the acquisition instructions 76 reprogram the acquisition to satisfy both requests. However, as seen in the third line of FIG. 3, adding sampling at 1 Hz at time S would result in misalignment of samples for the two applications 50, 52 and resultant excessive sampling to satisfy both applications 50, 52. To avoid this excessive sampling, the first sample acquisition for the exercise monitoring application 50 is suitably postponed or temporally shifted so until it aligns with a next sample acquisition for the trending application 52. As shown in the last line of FIG. 3, with this shift every fifth sample of the heart rate data stream 32 is used for the trending application 52, while all samples are used for the exercise monitoring application.

In other embodiments, the sampling rate f_{HR,acq} for the heart rate data stream 32 is set to the frequency that is equal to the smallest common multiple of the requested frequencies. This approach allows more flexibility in setting different access rates for different applications, but may require more sampling. For example, if two applications access the same data stream with access rates of 2 Hz and 3 Hz, respectively, both applications can be satisfied by f_{HR,acq}=6 Hz.

With returning reference to FIGS. 1 and 2, the distributed shared data space 30 exists as a plurality of instances 41, 42, 43 distributed across several devices 10, 12, 14. The acquisition instructions 76 executing on any given device append data to the data stream of the data space instance stored on that device. This data is then transferred to other devices of the system by execution of the synchronization instructions 72. This synchronizing transfer may occur substantially simultaneously with the acquisition and storage on the initial device (if, for example, the devices are connected at the time of acquisition) or later. For example, when the pulse oximeter 10 acquires an SpO₂ sample, it stores the value by appending it to the SpO₂ data stream of the shared data space instance 41 stored on the pulse oximeter 10. At this time, the other devices 12, 14 are “out of synch” with the pulse oximeter 10, since the newly acquired SpO₂ datum is stored only in the data space instance 41 of the pulse oximeter 10. To correct this situation, the synchronization instructions 72 on the pulse oximeter 10 and on the laptop computer 14 arrange transfer the SpO₂ datum to the laptop computer 14 the next time the patient visits the physician. If the patient is carrying the PDA 12 during this visit to the physician's office, then the synchronization instructions 72 on the PDA 12 and on the laptop computer 14 arrange further transfer of the SpO₂ datum from the laptop computer 14 to the PDA 12, thus completing synchronization of the copies of the SpO₂ data stream in the three instances 41, 42, 43 of the shared data space 30 respective to that SpO₂ datum. This processing is repeated, in an ad hoc manner, for each newly acquired data stream sample so as to keep copies of the data streams in the three instances 41, 42, 43 of the shared data space 30 synchronized with one another.

When two devices are operatively connected, the time synchronization instructions 74 optionally also operate to synchronize the clocks of the two devices. For example, at the time that the pulse oximeter 10 and the laptop computer 14 are connected, the time synchronization instructions 74 can transmit a time synchronization signal from one device to the other to synchronize the clocks 81, 83 of the pulse oximeter 10 and laptop computer 14, respectively.

While not shown in the embodiment of FIGS. 1-3, it is contemplated to use one device having storage as a “hub” device. Such a hub device, if designated, should be frequently accessed by each and every device having storage in the personal health system, and each device synchronizes only with the hub device. For example, if the PDA 12 (which already has direct connectivity with the laptop computer 14) additionally has connectivity with pulse oximeter 10, then the PDA 12 could serve as the hub device, and each of the pulse oximeter 10 and laptop computer 14 would synchronize with the PDA 12 alone. In these embodiments, the pulse oximeter 10 and laptop computer 14 would not directly synchronize with each other, even if they are operatively connected. Using a hub can have certain advantages in terms of ensuring more rapid and consistent synchronization, since the system is configured so that every other device has frequent synchronization access with the hub device. Also, by having the time synchronization instructions 74 synchronize all clocks with the clock of the hub device, temporal drift or offsets can be reduced. In some contemplated embodiments in which every device in the personal health system has Internet connectivity, the hub device can be embodied as a URL on the Internet. Each device accesses the hub URL to synchronize its data space instance with the hub data space instance at the hub URL, and also synchronizes its clock with a hub clock at the hub URL.

In some other embodiments, there may be only a single device with storage in the personal health system. For example, one contemplated personal health system includes a plurality of sensors without storage, each of which communicates with the PDA. The PDA then stores a single instance of the shared data space and runs one or more application programs. In such an embodiment, the shared data space is suitably not a distributed shared data space, and the synchronization and time synchronization instructions 72, 74 are suitably omitted from the interfacing software, or are not included with the instance of the interfacing software on the single device with storage. These embodiments that use only a single device with storage retain the advantages of decoupling data readout by the applications from the data acquisition and storage, and facilitate use of the same data stream by multiple applications. Although in these embodiments the system includes only a single device with storage and a single instance of the shared data space, it is contemplated for the shared data space to be backed up (that is, copied) occasionally to another device that is not itself part of the system.

In an actually constructed embodiment similar to that of FIGS. 1-3, a personal health system included a PDA that served as a hub device, a laptop computer, and a heart rate sensor. The heart rate sensor was connected to the PDA via a wireless 802.15.4 link. The PDA and laptop communicated via a Bluetooth connection. A sports application was run on the PDA, which asked the interfacing software to collect heart rate samples at a frequency of 1 Hz when the patient was running. The laptop computer was a physician's laptop computer containing a trending application. During visits by the patient to the physician, the PDA is connected with the laptop computer, and the trending application asked the interfacing software to collect heart rate samples at a frequency of 1/60 Hz. Both the PDA and the laptop computer had loaded instances of the interfacing software and instances of the distributed shared data space. When the PDA and the laptop were connected, both data space instances were synchronized by exchanging samples using an IP socket. Once the interfacing software asked the sensor to start sampling at a certain frequency, the sensor autonomously sent the heart rate at this frequency. When a sample could not be delivered (e.g., because the connection between the sensor and the PDA was broken), both the sensor and the PDA raised an alarm to inform the user that something was wrong. This alarm was raised only after a sample could not be taken. The prototype confirmed that the system continued to operate correctly even with an intermittent device connection. In the prototype personal health system, the clocks of the heart rate sensor and the PDA drifted apart at a rate of about 10 milliseconds per minute. The prototype personal health system was modified to include time synchronization instruction which sent a clock synchronization message from the PDA to the sensor every 10 minutes. This modification was found to keep the clock drift within acceptable limits.

With reference to FIG. 4, another contemplated embodiment is illustrated. This embodiment includes a wrist-band based sensor 116 including heart rate and SpO₂ monitors, and employs a shared data space 130 with heart rate and SpO2 data streams 132, 134, respectively. The shared data space 130 is substantively similar to the shared data space 30, but is maintained and operated in the context of an in-home personal care system that includes a set-top box 150 configured to operate in conjunction with a television 152, home entertainment system, or other audio-video device. The set-top box 150 is also in communication with the sensor 116 (either wirelessly, e.g. using a Bluetooth or Zigbee connection or the like, or by a wired connection) and with a remote personal patient care server 154. The remote server 154 is typically a computer server or other digital device located at a hospital or other medical facility staffed by physicians, nurses, or other medical professionals. In the illustrated embodiment, the set-top box 150 is connected by a coaxial radio frequency cable 155 of a conventional cable television network to a local station 156 that is also connected with the remote server 154 via a coaxial radio frequency cable 157. However, other interconnections can be used, such as a wireless satellite television network, wireless cellular telephone network, high-speed digital subscriber line (DSL) operating over a conventional telephone network, or so forth.

The remote server 154 executes health care modules to the set-top box 150 for presentation to the patient. Alternatively, the remote server 154 can deliver health care modules to the set-top box 150 which optionally includes a microprocessor, memory, and other hardware and software sufficient to execute the health care modules. Example illustrated health care modules include a weight loss goal module 160, an exercise goal module 162, and a trending module 164. The weight loss and exercise goal modules 160, 162 present programs for guiding the patient in weight loss and exercise programs, respectively. These goal modules 160, 162 may include passive audio-video, or may be interactive modules including audio-video and patient feedback portions such as interactive surveys, questionnaires, review questions, or so forth that are displayed on the television 152 and responded to using a hand-held remote control device 166.

The illustrated goal modules 160, 162 advantageously make use of heart rate and/or SpO₂ data from the wrist-band based sensor 116. Additionally, the trending module 164 provides periodic measurement of heart rate and/or SpO₂ to provide trending data for later analysis by the patient's physician. Advantageously, all three modules 160, 162, 164 can utilize the same sensor 116 via the shared data space 130. The shared data space 130 is illustrated as a single unit, which is representative of its logical configuration; however, it will be appreciated that the shared data space 130 may be stored as a distributed shared data space by storing instances of the shared data space 130 on each of the set-top box 150 and the remote server 154. Both the set-top box 150 and the remote server 154 include installed instances 170, 171 of the interfacing software. Both instances 170, 171 include the setup, synchronization, and time-synchronization instructions 70, 72, 74 which enable establishment of instances of the shared data space 130 on each device 150, 154, and which enable time synchronization between the devices 150, 154. The interfacing software instance 170 of the set-top box 150 also includes the acquisition instructions 76 to enable acquisition of heart rate and/or SpO₂ data from the sensor 116. In this embodiment, the sensor 116 does not run the interfacing instructions, but is programmable to set a rate of data output in Hertz or another suitable frequency unit, and can be set via communicated instructions to output heart rate, SpO₂, both, or neither. The interfacing software instance 170 of the set-top box 150 further includes the acquisition control instructions 80 to enable an application to set which data to acquire (heart rate and/or SpO₂) and the acquisition frequency or frequencies, and output instructions 78 to output heart rate and/or SpO₂ data to an application running on the set-top box 150 that displays the heart rate and/or SpO₂ data on the television 152. (In some embodiments, all application software executes on the remote server 154, in which case the output instructions 78 are optionally omitted). The interfacing software instance 171 of the remote server 154 further includes the acquisition control instructions 80 to enable an application to set which data to acquire (heart rate and/or SpO₂) and the acquisition frequency or frequencies, and output instructions 78 to output heart rate and/or SpO₂ data to an application running on the remote server 154. For example, the application may be a trending application that stores samples of heart rate and/or SpO₂ in a file for later plotting as a graph or other trending display.

Occasionally, the synchronization instructions 70 operate to synchronize the instances of the shared data space 130 on the remote server 154 and on the set-top box 150. Similarly, the time synchronization instructions 72 operate occasionally to provide time synchronization of the devices 150, 154. These operations are transparent to application such as the modules 160, 162, 164. Moreover, each of the modules 160, 162, 164 accesses the shared data space 130 at its own acquisition frequency independently of the other modules. The lower-level processing such as synching up different acquisition rates of different applications (for example, as shown in FIG. 3) is performed by the interfacing software and is again transparent to the applications. Thus, the shared data space 130 including data streams 132, 134 enable the different applications 160, 162, 164 to use the same sensor 116 without modifications to the applications 160, 162, 164.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A system for data acquisition, storage, and access, the system comprising:
an electronic device having storage, at least a portion of the storage of the electronic device containing a shared data space configured to store one or more data streams of temporally ordered time-stamped values;
one or more data sources; and
interfacing software defining (i) acquisition instructions executable by the electronic device to acquire and store in a first data stream of the shared data space time-stamped samples acquired from a first data source of the one or more data sources at a first temporal acquisition frequency, (ii) output instructions executable by the electronic device to output to a first application selected values from the first data stream at a first application first data stream access frequency, and (iii) acquisition control instructions executable by the electronic device to request the continuous acquisition of data samples at a specified frequency.

2. The system as set forth in claim 1, wherein the acquisition control instructions are further executable by the electronic device to set the first temporal acquisition frequency and the first application first data stream access frequency such that successive selected values are contiguous in the first data stream or are separated in the first data stream by a constant integer number of intervening time-stamped values.

3. The system as set forth in claim 1, wherein the acquisition control instructions are further executable by the electronic device to acquire and store in a second data stream of the shared data space time-stamped samples acquired from a second data source of the one or more data sources at a second temporal acquisition frequency, and the output instructions are further executable by the electronic device to output to the first or another application selected values for processing from the second data stream at a first or other application second data stream access frequency.

4. The system as set forth in claim 1, wherein the output instructions are further executable by the electronic device to output to a second application selected values from the first data stream at a second application first data stream access frequency.

5. The system as set forth in claim 4, wherein the acquisition control instructions are further executable by the electronic device to set the first application first data stream access frequency and the second application first data stream access frequency such that:
the first application first data stream access frequency and the second application first data stream access frequency are equal, or
the first application first data stream access frequency is an integer multiple of the second application first data stream access frequency, or
the second application first data stream access frequency is an integer multiple of the first application first data stream access frequency.

6. The system as set forth in claim 1, wherein the electronic device having storage includes a plurality of electronic devices having storage, and the interfacing software further defines synchronization instructions executable on each electronic device to at least intermittently synchronize different instances of the shared data space stored on different ones of the electronic devices having storage.

7. The system as set forth in claim 6, wherein the synchronization instructions are further executable on each electronic device to at least intermittently synchronize clocks of the electronic devices.

8. The system as set forth in claim 6, wherein at least one device of the plurality of electronic devices with storage has integrated therewith at least one data source of the one or more data sources

9. The system as set forth in claim 6, wherein at least one data source of the one or more data sources is in direct communication with only a sub-set of the plurality of electronic devices with storage.

10. The system as set forth in claim 6, wherein the acquisition instructions are executable on a first one or more of the plurality of electronic devices and the output instructions are independently executable on a second one or more of the plurality of electronic devices not identical with the first one or more of the plurality of electronic devices, and the acquisition control instructions are independently executable on a third one or more of the plurality of electronic devices not identical with the first or second one or more of the plurality of electronic devices.

11. The system as set forth in claim 1, wherein the output instructions, the acquisition instructions, and the acquisition control instructions operate independently and asynchronously respective to one another.

12. An electronic device configured for use in the system of claim 1.

13. A digital medium or media with the interfacing software of claim 1.

14. A method for data acquisition, storage, and access, the method comprising:
defining a shared data space configured to store one or more data streams of temporally ordered time-stamped values;
acquiring and storing in a first data stream of the shared data space time-stamped samples acquired from a first data source at a first temporal acquisition frequency; and
outputting to a first application selected values from the first data stream at a first application first data stream access frequency.

15. The method as set forth in claim 14, further including:
selecting first temporal acquisition frequency and the first application first data stream access frequency such that successive selected values are contiguous in the first data stream or are separated in the first data stream by a constant integer number of intervening time-stamped values.

16. The method as set forth in claim 14, further including:
acquiring and storing in a second data stream of the shared data space time-stamped samples acquired from a second data source of the one or more data sources at a second temporal acquisition frequency; and
outputting to the first or another application selected values for processing from the second data stream at a first or other application second data stream access frequency.

17. The method as set forth in claim 14, further including:
outputting to a second application selected values from the first data stream at a second application first data stream access frequency.

18. The method as set forth in claim 17, further including:
selecting the first application first data stream access frequency and the second application first data stream access frequency such that:
the first application first data stream access frequency and the second application first data stream access frequency are equal, or
the first application first data stream access frequency is an integer multiple of the second application first data stream access frequency, or
the second application first data stream access frequency is an integer multiple of the first application first data stream access frequency.

19. The method as set forth in claim 14, wherein the defining of the shared data space includes:
storing instances of the shared data space on two or more electronic devices having storage; and
at least intermittently synchronizing the instances of the shared data by communication between the electronic devices.

20. The method as set forth in claim 19, further including:
at least intermittently exchanging a clock synchronization signal between the two or more electronic devices so as to synchronize clocks of the electronic devices used in assigning time stamps.

21. A system for data acquisition, storage, and access including means for performing each of the process operations of claim 14.

22. A storage medium or media storing interfacing software for use in conjunction with data acquisition, storage, and access, the interfacing software defining (i) setup instructions for establishing on each of one or more electronic devices having storage an instance of a shared data space configured to store one or more data streams of temporally ordered time-stamped values, (ii) acquisition instructions executable by at least one device of the one or more electronic devices to acquire and store in a first data stream of the shared data space time-stamped samples acquired from a first data source at a first temporal acquisition frequency, (iii) output instructions executable by at least one device of the one or more electronic devices to output to a first application selected values from the first data stream at a first application first data stream access frequency, and (iv) acquisition control instructions executable by at least one device of the one or more electronic devices to instruct the system to start the continuous acquisition of data samples at a specified frequency and moment.

23. The storage medium or media as set forth in claim 22, wherein the interfacing software further defines (v) synchronization instructions executable on each of the one or more electronic devices to at least intermittently synchronize the instances of the shared data space.

24. An electronic device comprising:
storage which contains a shared data space configured to store one or more data streams of temporally ordered time-stamped values;
a processor which executes instructions to acquire and store in a first data stream of the shared data space time-stamped samples acquired from a first data source of the one or more data sources at a first temporal acquisition frequency and to output to a first application selected values from the first data stream at a first application first data stream access frequency.
